(19) United States
(12) Patent Application Publication
(10) Pub. No.: US 2025/0243773 A1
(43) Pub. Date: Jul. 31, 2025

(54) CERAMIC ABRADABLE COATING WITH CONTROLLABLE HARDNESS AND ABRADABILITY

(71) Applicant: RTX Corporation, Farmington, CT (US)

(72) Inventors: Nizar B. Zahed, Glastonbury, CT (US); Anna M. Mercaldi, Newington, CT (US); Mackenzie Vinson, Manchester, CT (US); Agnieszka M. Wusatowska-Sarnek, Washington, DC (US)

(21) Appl. No.: 18/428,738

(22) Filed: Jan. 31, 2024

(51) Int. Cl. F01D 11/12; C04B 35/622; C23C 4/08; C23C 4/11; C23C 4/134

(52) U.S. Cl. CPC F01D 11/122; F01D 5/286; F01D 5/288; F05D 2230/90; F05D 2300/611

(57) ABSTRACT

An abradable coating comprising a ceramic matrix layer disposed on a bond coat layer, wherein the abradable coating has a micro-hardness of 35 to 60 as measured on the Rockwell HRC hardness scale in accordance with ASTM E18.

### BACKGROUND

### Field

The subject matter disclosed herein generally relates to ceramic abradable coatings, methods of production thereof, and methods of use thereof in turbomachinery.

### Description of Related Art

Turbomachinery, such as gas turbine engines, typically have rotors with one or more rows of rotating blades located in close proximity to a stationary surface which is, or acts as, a seal. To maximize engine efficiency, leakage of gas or working fluid around the blade tips are preferably minimized. This may be achieved by configuring the blade tips and a seal with minimum blade tip clearance leading to periodic contact between the blade tips and the seal during operation of the turbomachine. Generally, the blade tips are supplied with a hard and abrasive coating and the seal can be provided with an abradable coating. Thus, when the blade tips contact the seal, the blade tips can abrade or cut into the abradable coating on the seal to prevent damage to the blade tips. During certain gas turbine engine operating conditions, radial interactions between the blade tips and the abradable seals can damage the blade tips if the abradable seals are too hard to abrade. Damaged blade tips impose a significant risk to engine life and safety. Accordingly, an abradable coating on the seal can be desirable.

A typical abradable coating is produced with air plasma spray and includes a metallic and/or ceramic matrix with dislocators and porosity to provide abradability. Because the deposition process for the metallic or ceramic matrix is stochastic, control of deposition is limited leading to local variations of abradability and other properties throughout the coating. Variability in the coating can lead to undesirable blade tip wear and increased frictional heating.

There remains a need for improved abradable coatings and methods of production thereof to enable reduced clearance of abradable coated components during gas turbine engine operation.

### SUMMARY

An abradable coating including a ceramic matrix layer disposed on a bond coat layer, wherein the abradable coating has a micro-hardness of 35 to 60 as measured on the Rockwell HRC hardness scale in accordance with ASTM E18.

In one aspect, the abradable coating has a porosity of 1% to 80% as measured in accordance with ASTM E1920.

In another aspect, the ceramic matrix layer includes aluminum oxide, titanium oxide, lanthanum zirconate, gadolinium zirconate, yttria-stabilized zirconia, or a combination thereof.

In yet another aspect, the bond coat layer includes a nickel alloy or an aluminum alloy.

In yet another aspect, the nickel alloy includes aluminum, boron, carbon, chromium, cobalt, copper, molybdenum, titanium, yttrium, zirconium, or a combination thereof, with the remainder being nickel, wherein the aluminum alloy includes copper, manganese, silicon, magnesium, zinc, or a combination thereof, with the remainder being aluminum.

In yet another aspect, the bond coat layer has a thickness of 0.003 inches to 0.008 inches and/or the ceramic matrix layer has a thickness of 0.020 inches to 0.150 inches.

A gas turbine engine component coated with the abradable coating wherein the bond coat layer is disposed on the gas turbine engine component and the ceramic matrix layer is disposed on the bond coat layer, wherein the abradable coating covers 25% to 100% of the surface of the gas turbine engine component.

In an aspect, the gas turbine engine component has a first side and a second side, wherein the first side forms a seal with a stationary surface.

In another aspect, the abradable coating is at least on the second side of the gas turbine engine component.

In yet another aspect, the second side of the gas turbine engine component is placed facing a rotor.

In yet another aspect, the abradable coating on the gas turbine engine component has a micro-hardness that is 15% to 60% of the micro-hardness of the rotor as measured in accordance with ASTM E18.

A method of operating a gas turbine engine, wherein the gas turbine engine component is a seal and the seal is used in a gas turbine engine, wherein the abradable coating on the seal is placed facing a rotor and the abradable coating on the seal is abraded by the rotor during operation of the gas turbine engine.

A method of manufacturing an abradable coating on a component including: providing the component; disposing a bond coat on the component; disposing a ceramic matrix layer on the bond coat to provide an as-coated component, wherein the bond coat layer and the ceramic matrix layer on the as-coated component comprise a first coating and soaking the as-coated component in a hydroxide solution to convert the first coating into the abradable coating.

In one aspect, the bond coat layer and/or the ceramic matrix layer are applied by air plasma spray.

In another aspect, the hydroxide solution includes lithium hydroxide, potassium hydroxide, sodium hydroxide, ammonium hydroxide, or a combination thereof.

In yet another aspect, the hydroxide solution has a hydroxide concentration of 10 volume percent to 50 volume percent.

In yet another aspect, the coated component is soaked in the hydroxide solution for 2 minutes to 60 minutes at a temperature of 60° C. to 100° C.

In yet another aspect, the micro-hardness of the abradable coating is 15% to 60% of the micro-hardness of the first coating as measured in accordance with ASTM E18.

In yet another aspect, the abradability of the abradable coating is 200% to 500% of the abradability of the first coating.

### BRIEF DESCRIPTION OF THE FIGURES

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a simplified cross sectional view of a gas turbine engine;

FIG. 2 is a simplified cross sectional view illustrating the relationship of the rotor and vanes along line 2-2 of FIG. 1;

FIG. 3 is a cross sectional view along line 3-3 of FIG. 2,

FIG. 4 is a simplified cross sectional view illustrating the relationship of the casing or shroud and blades along line 4-4 of FIG. 1;

FIG. 5 is a cross sectional view along line 5-5 of FIG. 4;

FIG. 6 is a schematic diagram of an embodiment of an abradable coating on a component; and

FIG. 7 is a flow diagram of a method of preparing a component with an abradable coating.

### DETAILED DESCRIPTION

The exemplary embodiments disclosed herein are illustrative of abradable coatings for a component (e.g., a seal in a gas turbine engine), and methods of use and production thereof. It should be understood, however, that the disclosed embodiments are merely examples of the present disclosure, which may be embodied in various forms. Therefore, details disclosed herein with reference to example abradable coatings, components coated with an abradable coating, and associated methods of use and manufacture thereof are not to be interpreted as limiting, but merely as the basis for teaching one skilled in the art about the abradable coatings and how to make and use the abradable coatings of the present disclosure.

Disclosed therein is an abradable coating, having a micro-hardness suited for contact with abrasive components. The abradable coating can be disposed on gas turbine engine components to prevent or limit damage to components that come into contact with the abradable coating. The hardness and abradability of the abradable coating can be tailored to accommodate the materials and properties of contacting components. Methods of use of components coated with the abradable coating include use of the components as a seal with an abradable coating in a gas turbine engine. During use, the abradable coating on the seal can face a rotor with minimum rotor clearance. In this manner the abradable coating on the seal can serve to prevent and limit damage to the rotor by being abraded by the rotor when the components come into contact during operation of the gas turbine engine. The method of manufacture of the abradable coating is easily adaptable to a wide variety of ceramic materials. Application of the method of producing the abradable coating provides ready access to abradable coatings with tailorable hardness and abradability.

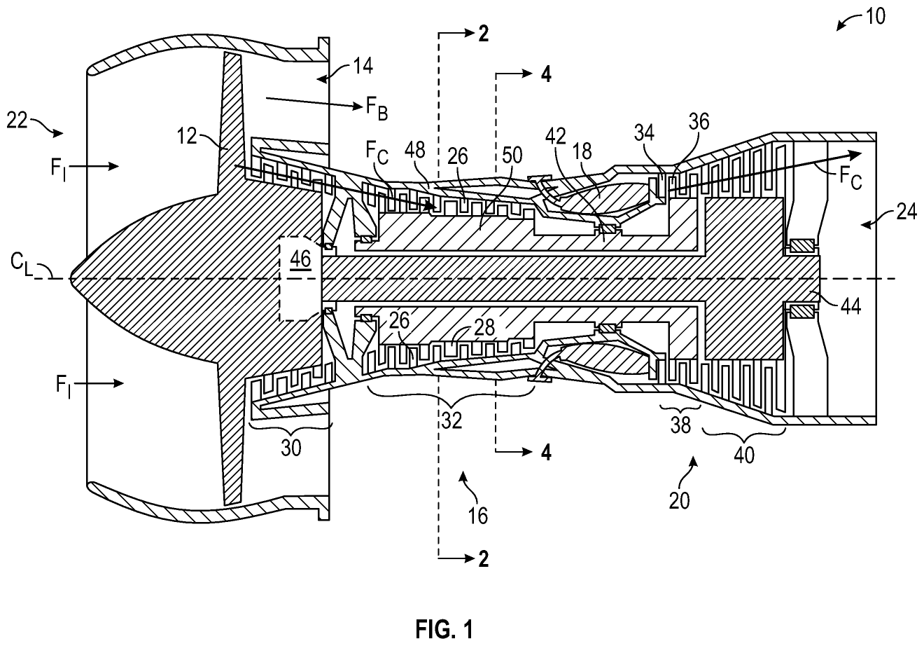

FIG. 1 is a cross-sectional view of a gas turbine engine 10, in one turbofan embodiment. As shown in FIG. 1, turbine engine 10 comprises fan 12 positioned in bypass duct 14, with bypass duct 14 oriented about a turbine core comprising compressor (compressor section) 16, combustor (or combustors) 18 and turbine (turbine section) 20, arranged in flow series with upstream inlet 22 and downstream exhaust 24.

Compressor 16 comprises stages of compressor vanes 26 and blades 28 arranged in low pressure compressor (LPC) section 30 and high pressure compressor (HPC) section 32. Turbine 20 comprises stages of turbine vanes 34 and turbine blades 36 arranged in high pressure turbine (HPT) section 38 and low pressure turbine (LPT) section 40. HPT section 38 is coupled to HPC section 32 via HPT shaft 42, forming the high pressure spool or high spool. LPT section 40 is coupled to LPC section 30 and fan 12 via LPT shaft 44, forming the low pressure spool or low spool. HPT shaft 42 and LPT shaft 44 are typically coaxially mounted, with the high and low spools independently rotating about turbine axis (centerline) CL.

Fan 12 comprises a number of fan airfoils circumferentially arranged around a fan disk or other rotating member, which is coupled (directly or indirectly) to LPC section 30 and driven by LPT shaft 44. In some embodiments, fan 12 is coupled to the fan spool via geared fan drive mechanism 46, providing independent fan speed control.

As shown in FIG. 1, fan 12 can be forward-mounted and provide thrust by accelerating flow downstream through bypass duct 14, for example in a high-bypass configuration suitable for commercial and regional jet aircraft operations. Alternatively, fan 12 can be an unducted fan or propeller assembly, in either a forward or aft-mounted configuration. In these various embodiments turbine engine 10 comprises any of a high-bypass turbofan, a low-bypass turbofan or a turboprop engine, and the number of spools and the shaft configurations may vary.

In operation of turbine engine 10, incoming airflow FI enters inlet 22 and divides into core flow FC and bypass flow FB, downstream of fan 12. Core flow FC propagates along the core flowpath through compressor section 16, combustor 18 and turbine section 20, and bypass flow FB propagates along the bypass flowpath through bypass duct 14.

LPC section 30 and HPC section 32 of compressor 16 are utilized to compress incoming air for combustor 18, where fuel is introduced, mixed with air and ignited to produce hot combustion gas. Depending on embodiment, fan 12 also provides some degree of compression (or pre-compression) to core flow FC, and LPC section 30 may be omitted. Alternatively, an additional intermediate spool is included, for example in a three-spool turboprop or turbofan configuration.

Combustion gas exits combustor 18 and enters HPT section 38 of turbine 20, encountering turbine vanes 34 and turbine blades 36. Turbine vanes 34 turn and accelerate the flow, and turbine blades 36 generate lift for conversion to rotational energy via HPT shaft 42, driving HPC section 32 of compressor 16 via HPT shaft 42. Partially expanded combustion gas transitions from HPT section 38 to LPT section 40, driving LPC section 30 and fan 12 via LPT shaft 44. Exhaust flow exits LPT section 40 and turbine engine 10 via exhaust nozzle 24.

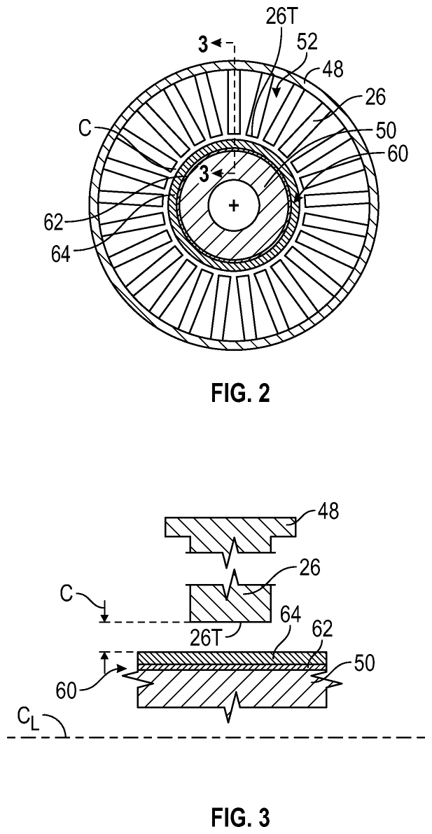

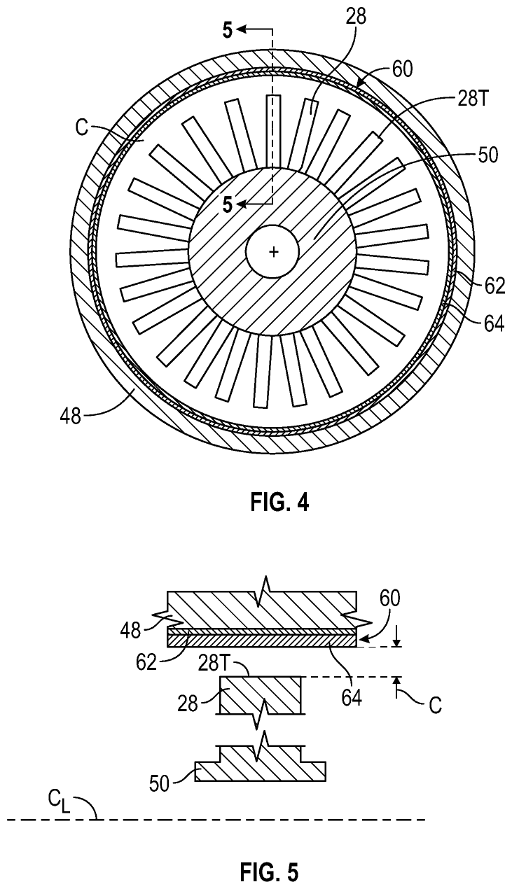

The disclosed abradable coating can be used with airfoils in a turbomachine. The term “airfoil” is intended to cover both rotor blades and stator vanes. FIG. 2 and FIG. 3 illustrate the use of the abradable coating with respect to interaction of a stator vane with a rotor. FIG. 4 and FIG. 5 illustrate the use of the abradable coating with respect to interaction of a rotor blade with a stator casing or shroud. The present abradable coating may be used with either or both configurations.

FIG. 2 is a cross section along line 22 of FIG. 1 of a casing 48 which has a rotor shaft 50 inside. Vanes 26 are attached to casing 48 and the gas path 52 is shown as the space between vanes 26. The abradable coating 60 is on rotor shaft 50 such that the clearance C between coating 60 and vane tips 26T of vanes 26 has the proper tolerance for operation of the engine, e.g., to serve as a seal to prevent leakage of air (thus reducing efficiency), while not interfering with relative movement of the vanes and rotor shaft. In FIGS. 2 and 3, clearance C is expanded for purposes of illustration. In practice, clearance C may be, for example, in a range of about 0.025 inch to 0.055 inch when the engine is cold and 0.000 inch to 0.035 inch during engine operation depending on the specific operating condition and previous rub events that may have occurred.

FIG. 3 shows the cross section along line 3-3 of FIG. 2, with casing 48 and vane 26. Coating 60 is attached to rotor shaft 50, with a clearance C between coating 60 and vane tip 26T of vane 26 that varies with operating conditions, as described herein.

FIG. 2 and FIG. 3 show the abradable coating 60 in which includes a bond coat layer 62 and a ceramic matrix layer 64. The bond coat layer 62 can be applied to rotor shaft 50. The ceramic matrix layer 64 can be deposited on top of the bond coat layer 62. The ceramic matrix layer 64 is the layer that first encounters vane tip 26T.

As can be seen from FIG. 4 and FIG. 5, the same concept is used in which coating 60 is provided on the inner diameter surface of casing or shroud 48. Coating 60 can include a bond coat layer 62 that has been applied to the ID of stator casing 48. In other embodiments, stator casing 48 includes a shroud that forms a blade air seal. The ceramic matrix layer 64 can be formed on the metallic bone coat layer 62 and can be the layer that first encounters rotor tip 28T.

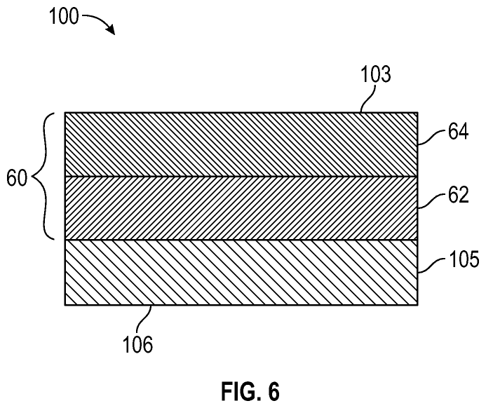

Referring to FIG. 6, a diagram of the abradable coating 60 is shown. The abradable coating 60 includes the bond coat layer 62 and the ceramic matrix layer 64. As shown in FIG. 6, the ceramic matrix layer 64 is disposed on the bond coat layer 62. In some embodiments, the bond coat layer 62 is disposed on a component 105 and the bond coat layer 62 can be disposed between the component 105 and the ceramic matrix layer 64. When the abradable coating 60 is coated on a component 105 it can provide the coated article. The abradable coating 60 can be placed on a portion of the component 105 as shown in FIG. 6, or can be coated over the total surface of the component 105. The abradable coating 60 disposed on the component 105 provides a component with an abradable coating (hereafter “coated component 100”). The abradable coating 60 can cover 25% to 100% of the surface of a component. Use of the coated component 100 in a gas turbine engine can include disposing the surface 106 of the component on a stationary surface of the engine and facing the surface 103 toward an abrasive component. During operation of the gas turbine engine, the seal can be abraded by the rotor in the event of incidental periodic contact between the seal and the rotor.

The abradable coating 60 can be applied to a component wherein the bond coat layer of the abradable coating is disposed between the component and the ceramic matrix layer of the abradable coating. The abradable coating can be disposed on the total surface of a component or a portion thereof. The abradable coating can be disposed on a single surface or face of a component surface. In some embodiments, the abradable coating can be disposed on 25% to 100% of the component surface.

The abradable coating 60 can be coated on a gas turbine engine component such as a rotor shaft or a stator casing as shown in FIGS. 2 and 4, respectively. The bond coat layer of the abradable coating can be disposed on the gas turbine engine component and the ceramic matrix layer can be disposed on the bond coat layer. The abradable coating can cover 25% to 100% of the surface of the gas turbine engine component. The gas turbine engine component can include a first side and a second side, wherein the first side forms a seal with a stationary surface. The second side of the gas turbine engine component can be placed in a gas turbine engine facing a rotor. The abradable coating can be on the first side the second side, or only on the second side of the gas turbine engine component. The abradable coating on the gas turbine engine component can serve to be abraded by the rotor during operation of the gas turbine engine.

The abradable coating can have a micro-hardness of a micro-hardness of 35 to 60 as measured with the Rockwell HRC hardness scale in accordance with ASTM E18. Porosity of the abradable coating can vary. Porosity can be 1% to 80%, 5% to 75%, or 20% to 70% as measured in accordance with ASTM E1920.

The ceramic matrix layer 64 can include aluminum oxide, titanium oxide, lanthanum zirconate, gadolinium zirconate, yttria-stabilized zirconia, or a combination thereof. The ceramic matrix layer can have a thickness of 0.020 inches (in.) to 0.150 in., or 0.075 in. to 0.100 in.

The bond coat layer 62 may comprise a ceramic matrix. The bond coat layer 62 may be metallic and formed of a metal alloy or a combination of metal alloys. The metal alloy can include aluminum, boron, carbon, chromium, cobalt, copper, magnesium, manganese, molybdenum, nickel, titanium, silicon, yttrium, zirconium, zinc, or a combination thereof. For example, the bond coat layer can include a nickel alloy or an aluminum alloy. The nickel alloy can include aluminum, boron, carbon, chromium, cobalt, copper, molybdenum, titanium, yttrium, zirconium, or a combination thereof, with the remainder being nickel. The aluminum alloy comprises copper, manganese, silicon, magnesium, zinc, chromium, molybdenum, or a combination thereof, with the remainder being nickel. Suitable examples of materials for the bond coat layer can include alloys of MCrAlY, where the metal (M) can be nickel, iron, or cobalt, or combinations thereof and the alloying elements can be chromium (Cr), aluminum (Al) and yttrium (Y). Other suitable alloys include NiAl, NiCrAlCo, and so forth. The bond coat layer can have a thickness of 0.003 in. to 0.008 in., or 0.005 in. to 0.006 in.

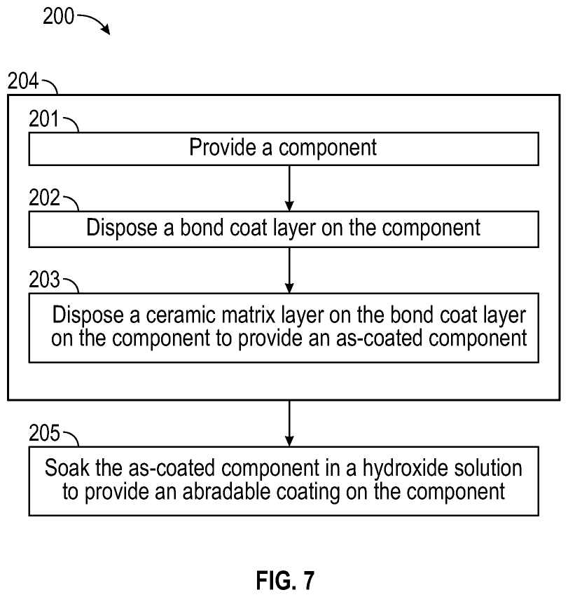

FIG. 7 provides a flow diagram of an embodiment of a method 200 for manufacturing the abradable coating 60. In step 201, a component can be provided. A bond coat layer is disposed on the component during step 202 then a ceramic matrix layer is disposed on the bond coat layer to provide an “as-coated” component where the bond coat layer and the ceramic matrix layer on the as-coated component form a first coating (step 203). Together steps 201 to 203 are a method of making the as-coated component (steps grouping labeled 204 in FIG. 7). Optionally after step 203, the as-coated component can be machined to a selected size. After step 203 or after an optional machining step, the as-coated component is further treated with a soak in a hydroxide solution (step 205) to convert the first coating into the abradable coating. Between steps 203 and 205, there can be an optional high temperature (e.g., temperatures greater than 270° C. or greater than 640° C.) heat treatment step to cure the coating on the as-coated component. In some embodiments, a high temperature heat treatment step is not performed between steps 203 and 205 further improving the efficiency of the method.

Stochastic application processes for the bond coat layer and/or the ceramic matrix layer can limit the controllability of the coating deposition and the location of dislocators and porogens. For example, the bond coat layer and/or the ceramic matrix layer can each be applied by air plasma spray. In general, air plasma spray can lead to variability throughout the abradability of a coating and also variability among multiple coated components and spray events. Such variability within the abradable coating can cause sub-optimal blade-seal interactions, which can manifest as uneven blade tip wear and large frictional heating. The method 200 provides a tailorable process to improve the uniformity of the abradable coating with control over the coating properties of hardness, porosity and thickness. For example, during step 205, the hydroxide salt type, concentration, time and temperature each affect the final properties of the abradable coating. Increased hydroxide solution concentration, increased soak time, and increased temperature soak solution can lead to increases in the thickness and porosity of the abradable coating concomitant with decreased hardness and increased abradability. With the disclosed method 200, abradable coatings can be manufactured in a controlled manner to provide abradability suited to a specific application.

The hydroxide solution can include lithium hydroxide, potassium hydroxide, sodium hydroxide, ammonium hydroxide or a combination thereof. The hydroxide solution has a hydroxide concentration of 10 percent volume (vol %) to 30 vol %, or 25 vol % to 50 vol %. The solute of the hydroxide solution can include water, aqueous buffers, or a combination thereof. The as-coated component can be soaked for 2 minutes to 60 minutes at a temperature of 60° C. to 100° C. After treatment in the hydroxide solution, the micro-hardness of the abradable coating is 15% to 60% the micro-hardness of the first coating as measured on the Rockwell HRC hardness scale in accordance with ASTM E18. The abradability of the abradable coating can be 200% to 500% of the abradability of the first coating.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

The ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” and so forth). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Although the coatings, components and methods of the present disclosure have been described with reference to example embodiments thereof, the present disclosure is not limited to such example embodiments and/or implementations. Rather, the coatings, components and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

1. An abradable coating comprising a ceramic matrix layer disposed on a bond coat layer, wherein the abradable coating has a micro-hardness of 35 to 60 as measured on the Rockwell HRC hardness scale in accordance with ASTM E18, wherein the ceramic matrix layer comprises titanium oxide, lanthanum zirconate, gadolinium zirconate, yttria-stabilized zirconia, or a combination thereof.

2. The abradable coating of claim 1, wherein the abradable coating has a porosity of 1% to 80% as measured in accordance with ASTM E1920.

3. (canceled)

4. The abradable coating of claim 1, wherein the bond coat layer comprises a nickel alloy or an aluminum alloy.

5. The abradable coating of claim 4, wherein the nickel alloy comprises aluminum, boron, carbon, chromium, cobalt, copper, molybdenum, titanium, yttrium, zirconium, or a combination thereof, with the remainder being nickel,
wherein the aluminum alloy comprises copper, manganese, silicon, magnesium, zinc, chromium, molybdenum, or a combination thereof, with the remainder being aluminum.

6. The abradable coating of claim 1, wherein the bond coat layer has a thickness of 0.003 inches to 0.008 inches and/or the ceramic matrix layer has a thickness of 0.020 inches to 0.150 inches.

7. A gas turbine engine component coated with the abradable coating of claim 1, wherein the bond coat layer is disposed on the gas turbine engine component and the ceramic matrix layer is disposed on the bond coat layer,
wherein the abradable coating covers 25% to 100% of a surface of the gas turbine engine component.

8. The gas turbine engine component of claim 7, wherein the gas turbine engine component has a first side and a second side, wherein the first side forms a seal with a stationary surface.

9. The gas turbine engine component of claim 8, wherein the abradable coating is at least on the second side of the gas turbine engine component.

10. The gas turbine engine component of claim 9, wherein the second side of the gas turbine engine component is placed facing a rotor.

11. The gas turbine engine component of claim 10, wherein the abradable coating on the gas turbine engine component has a micro-hardness that is 15% to 60% of the micro-hardness of the rotor as measured in accordance with ASTM E18.

12. A method of operating a gas turbine engine, wherein the gas turbine engine component of claim 7 is a seal and the seal is used in the gas turbine engine, wherein the abradable coating on the seal is placed facing a rotor and the abradable coating on the seal is abraded by the rotor during operation of the gas turbine engine.

13. A method of manufacturing an abradable coating on a component comprising:
providing the component;
disposing a bond coat on the component;
disposing a ceramic matrix layer on the bond coat to provide an as-coated component, wherein the bond coat layer and the ceramic matrix layer on the as-coated component comprise a first coating; and
soaking the as-coated component in a hydroxide solution to convert the first coating into the abradable coating.

14. The method of claim 13, wherein the bond coat layer and/or the ceramic matrix layer are applied by air plasma spray.

15. The method of claim 13, wherein the hydroxide solution comprises lithium hydroxide, potassium hydroxide, sodium hydroxide, ammonium hydroxide or a combination thereof.

16. The method of claim 13, wherein the hydroxide solution has a hydroxide concentration of 10 percent volume to 50 percent volume.

17. The method of claim 13, wherein the coated component is soaked in the hydroxide solution for 2 minutes to 60 minutes at a temperature of 60° C. to 100° C.

18. The method of claim 13, wherein the micro-hardness of the abradable coating is 15% to 60% of the micro-hardness of the first coating as measured in accordance with ASTM E18.

19. The method of claim 13, wherein the abradability of the abradable coating is 200% to 500% of the abradability of the first coating.
